(19) United States
(12) Patent Application Publication
(10) Pub. No.: US 2023/0364748 A1
(43) Pub. Date: Nov. 16, 2023

(54) Tight Space Wrench Device

(71) Applicants: James Moss, Morristown, TN (US); Kimberly Moss, Morristown, TN (US)

(72) Inventors: James Moss, Morristown, TN (US); Kimberly Moss, Morristown, TN (US)

(21) Appl. No.: 18/181,225

(22) Filed: Mar. 9, 2023

Related U.S. Application Data
(60) Provisional application No. 63/340,029, filed on May 10, 2022.

(51) Int. Cl. B25B 13/48; B25G 1/02

(52) U.S. Cl. CPC B25B 13/481; B25G 1/025

(57) ABSTRACT

The present invention relates to a tight space wrench device comprised of a wrench member attached to at least one chain with at least one loop that functions as a handle. The wrench member may have any wrench head known in the art that can be positioned on a fastener. The chain can then be positioned in any area away from the fastener wherein a user can comfortably grip the loop without the risk of injury to their hand. Then, a user can pull the chain to rotate the wrench head clockwise or counterclockwise.

### CROSS-REFERENCE TO RELATED APPLICATION

The present application claims priority to, and the benefit of, U.S. Provisional Application No. 63/340,029, which was filed on May 10, 2022, and is incorporated herein by reference in its entirety.

### FIELD OF THE INVENTION

The present invention relates generally to the field of wrenches. More specifically, the present invention relates to a tight space wrench device comprised of a wrench member attached to at least one chain with at least one loop that functions as a handle. The wrench member may have any wrench head known in the art that can be positioned on a fastener. The chain can then be positioned in any area away from the fastener wherein a user can comfortably grip the loop without the risk of injury to their hand. Then, a user can pull the chain to rotate the wrench head clockwise or counterclockwise. Accordingly, the present disclosure makes specific reference thereto. Nonetheless, it is to be appreciated that aspects of the present invention are also equally applicable to other like applications, devices, and methods of manufacture.

### BACKGROUND

Wrenches are a commonly used tool, especially for mechanics. However, traditional wrenches can be difficult to use in tight spaces (such as the engine bay of a piece of machinery or vehicle) when removing or securing fasteners. As a result, some working areas may not be able to accommodate a wrench and the necessary degree of movement of the wrench to achieve the amount of torque needed to tighten or loosen nuts, bolts, etc. As a result, individuals may injure their hands and wrists trying to squeeze wrenches into difficult areas.

Therefore, there exists a long-felt need in the art for an improved wrench. There also exists a long-felt need in the art for a tight space wrench device that can be easily used in small areas where traditional wrenches cannot be used due to lack of space. In addition, there exists a long-felt need in the art for a tight space wrench device that can be easily used in a small area without injuring the hands of a user.

The subject matter disclosed and claimed herein, in one embodiment thereof, comprises a tight space wrench device. The device is comprised of a wrench member attached to at least one chain with at least one loop that functions as a handle. The wrench member may have any wrench head known in the art. The wrench head can be positioned on a fastener, wherein the chain can then be positioned in any area away from the fastener wherein a user can comfortably grip the loop without the risk of injury to their hand. Then, a user can pull the chain to rotate the wrench head clockwise or counterclockwise. Alternatively, a user can insert a tool such as, but not limited to, a pry bar into the loop and use the pry bar to manipulate the chain to turn the wrench head.

In this manner, the tight space wrench device of the present invention accomplishes all of the foregoing objectives and provides an improved wrench. In doing so, the device provides a wrench that can be easily used in small areas where traditional wrenches cannot be used due to lack of space. In addition, the device does so without injuring the hands of a user.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tight space wrench device. The device is comprised of a wrench member attached to at least one chain with at least one loop that functions as a handle. The wrench member may be of a standard wrench length or may be shortened in various embodiments to allow the device to be used in small, tight spaces. The first end of the wrench member is comprised of at least one wrench head. In one embodiment, the first end has a crescent wrench head. In a second embodiment, the first end is comprised of a box wrench head. However, the first end may have any wrench head type known in the art which may be any size and/or configuration of wrench head known in the art.

The second end of the wrench member may be comprised of at least one opening that allows the first end of at least one chain to attach to the wrench member via the opening. In one embodiment, the chain attaches through the opening via at least one fastener. The fastener may allow the overall length of the chain to be adjusted by how much of the chain is fed through and secured around the opening using the fastener. In a differing embodiment, the chain is fixedly attached to the second end via a weld or other permanent attachment means.

In one embodiment, the chain is comprised of a plastic, flexible covering that encloses the chain such that it does not injure the hands of a user while a user grabs the chain during use. The covering may be textured to aid a user in gripping the chain. The covering may also be comprised of a textured rubber material. In one embodiment, the chain may be dipped in a synthetic covering such as, but not limited to, rubber.

The device is also comprised of a method of use. The second end of the chain is further comprised of at least one loop that functions as a handle that can be grabbed by the user. In this manner, the wrench member can be attached to a nut, bolt, fastener, etc., in a hard-to-reach area Then, the chain can then be positioned away from the said area in a space where the user's hand is not susceptible to injury due to a small space. The loop can then be grabbed by the user and pulled, such that the wrench member rotates clockwise or counterclockwise to tighten or loosen whatever the wrench member is engaging. In a differing embodiment, a pry bar or other long tool can be inserted into the loop such that the pry bar can be used to pull the chain, such that the wrench member rotates clockwise or counterclockwise to tighten or loosen whatever the wrench member is engaging.

Accordingly, the tight space wrench device of the present invention is particularly advantageous as it provides an improved wrench that can be easily used in small areas where traditional wrenches cannot be used due to lack of space. In addition, the device does so without injuring the hands of a user. In this manner, the tight space wrench device overcomes the limitations of existing wrenches known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of two potential embodiments of a tight space wrench device of the present invention comprised of a chain with a loop in accordance with the disclosed architecture;

FIG. 2 illustrates a flow chart of a method of using one potential embodiment of a tight space wrench device of the present invention in accordance with the disclosed architecture;

FIG. 3 illustrates a perspective view of two potential embodiments of a tight space wrench device of the present invention comprised of a chain in accordance with the disclosed architecture; and

FIG. 4 illustrates a perspective view of one potential embodiment of a tight space wrench device of the present invention comprised of a chain with a loop being used in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved wrench. There also exists a long-felt need in the art for a tight space wrench device that can be easily used in small areas where traditional wrenches cannot be used due to lack of space. In addition, there exists a long-felt need in the art for a tight space wrench device that can be easily used in a small area without injuring the hands of a user.

The present invention, in one exemplary embodiment, is comprised of a tight space wrench device comprised of a wrench member attached to at least one chain with at least one loop that functions as a handle. The wrench member may be of a standard wrench length or may be shortened in various embodiments to allow the device to be used in small, tight spaces. The first end of the wrench member is comprised of at least one wrench head that in the preferred embodiment, is a crescent wrench head or a box wrench head. However, the first end may have any wrench head type known in the which may be any size and/or configuration of wrench head known in the art.

The second end of the wrench member may be comprised of at least one opening that allows the first end of at least one chain to attach to the wrench member via the opening. In one embodiment, the chain attaches through the opening via at least one fastener that may allow the overall length of the chain to be adjusted by how much of the chain is fed through and secured around the opening using the fastener. In a differing embodiment, the chain is fixedly attached to the second end via a weld or other permanent attachment means.

In one embodiment, the chain is comprised of a plastic, flexible covering that encloses the chain such that it does not injure the hands of a user while a user grabs the chain during use. The covering may be textured to aid a user in gripping the chain. The covering may also be comprised of a textured rubber material. In one embodiment, the chain may be dipped in a synthetic covering such as, but not limited to, rubber.

The device is also comprised of a method of use. The second end of the chain is further comprised of at least one loop that functions as a handle that can be grabbed by the user. In this manner, the wrench member can be attached to a nut, bolt, fastener, etc., in a hard-to-reach area. Then, the chain can then be positioned away from said area in a space where the user's hand is not susceptible to injury due to a small space. The loop can then be grabbed by the user and pulled such that the wrench member rotates clockwise or counterclockwise to tighten or loosen whatever the wrench member is engaging. In a differing embodiment, a pry bar or other long tool can be inserted into the loop such that the pry bar can be used to pull the chain such that the wrench member rotates clockwise or counterclockwise to tighten or loosen whatever the wrench member is engaging.

Accordingly, the tight space wrench device of the present invention is particularly advantageous as it provides an improved wrench that can be easily used in small areas where traditional wrenches cannot be used due to lack of space. In addition, the device does so without injuring the hands of a user. In this manner, the tight space wrench device overcomes the limitations of existing wrenches known in the art.

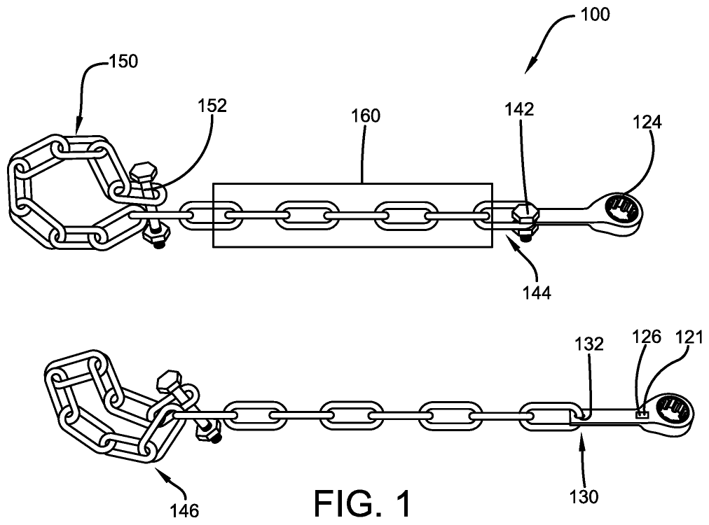

Referring initially to the drawings, FIG. 1 illustrates a perspective view of two potential embodiments of a tight space wrench device 100 of the present invention comprised of a chain with a loop in accordance with the disclosed architecture. The device 100 is comprised of a wrench member 110 attached to at least one chain 140 with at least one loop 150 that functions as a handle. The device 100 and all components are preferably made from a durable metal such as, but not limited to, a stainless steel or aluminum material. The wrench member 110 may be of a standard wrench length or may be shortened in various embodiments to allow the device 100 to be used in small, tight spaces.

The first end 120 of the wrench member 110 is comprised of at least one wrench head. In one embodiment, the first end 120 has a crescent wrench head 122. In a second embodiment, the first end 120 is comprised of a box wrench head 124. However, the first end 120 may have any wrench head type known in the art such as, but not limited to, open-ended wrench, line wrench, torque wrench, adjustable wrench, ratchet wrench, socket wrench, monkey wrench, pedal wrench, armorers wrench, pliers wrench, Allen wrench, universal wrench, oil filter wrench, crowfoot wrench, basin wrench, pipe wrench, etc. The wrench head type of the first end 120 may be any size and/or configuration of wrench head known in the art. In one embodiment, the wrench heads 122,124 (of many wrench styles) may be comprised of at least one female fastener 126 that engages at least one male fastener 121 of the first end 120. In this manner, one wrench member 110 can be used with multiple wrench heads 122,124. The fasteners 121,126 may be any reciprocating fastener type known in the art such as, but not limited to, magnet, tongue and groove, snap button, locking, threaded, etc.

The second end 130 of the wrench member 110 may be comprised of at least one opening 132. The opening 132 allows the first end 144 of at least one chain 140 to attach to the wrench member 110 via the opening 132. In one embodiment, the chain 140 attaches through the opening 132 via at least one fastener 142 such as, but not limited to, a clip, a clasp, a locking fastener, a nut and bolt assembly, etc. In this manner, the overall length of the chain 140 can be adjusted by how much of the chain 140 is fed through and secured around the opening 132 using the fastener 142. In one embodiment, the fastener 142 is a ball and socket joint that allows the chain 140 to rotate in any direction around the wrench member 110. The ball and socket joint may be a locking joint that allows the chain 140 to be fixed at a specific angle relative to the member 110. In a further embodiment, the fastener 142 may be at least one hinge such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. In a differing embodiment, the chain 140 is fixedly attached to the second end 130 via a weld or other permanent attachment means.

In differing embodiments, the chain 140 may be any chain type of any size but is preferably a linked chain. The chain 140 may alternatively be a rope in a differing embodiment of the device 100, wherein the rope is any rope type known in the art such as, but not limited to, a natural rope, a synthetic rope, a single braid rope, a plaited rope, a twisted rope, a double braid rope, a hollow rope, a manila rope, a polypropylene rope, a nylon rope, a bungee shock cord, a metal braided rope, etc.

In one embodiment, the chain 140 is comprised of a plastic, flexible covering 160 that encloses the chain 140 such that it does not injure the hands of a user while a user grabs the chain 140 during use. The covering 160 may be any plastic-type known in the art such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The covering 160 may be textured to aid a user in gripping the chain 140. The covering 160 may also be comprised of a textured rubber material such as, but not limited to, natural rubbers, neoprene rubber elastomer, silicone rubber elastomer, ethylene propylene diene monomer rubber, butyl rubber, nitrile rubber, buna-n rubber, styrene-butadiene rubber elastomers, viton rubber elastomer, diaphragm rubber, thermoplastic rubber, etc. In one embodiment, the chain 140 may be dipped in a synthetic covering such as, but not limited to, rubber.

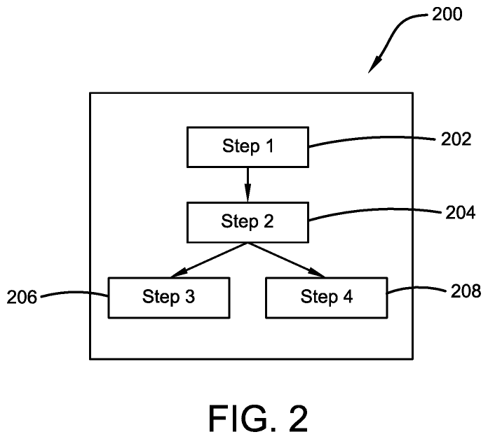

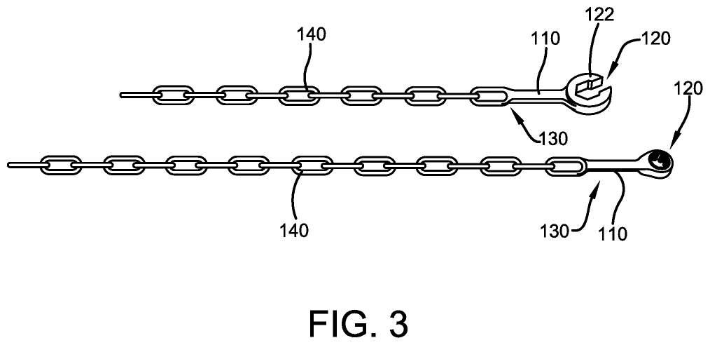

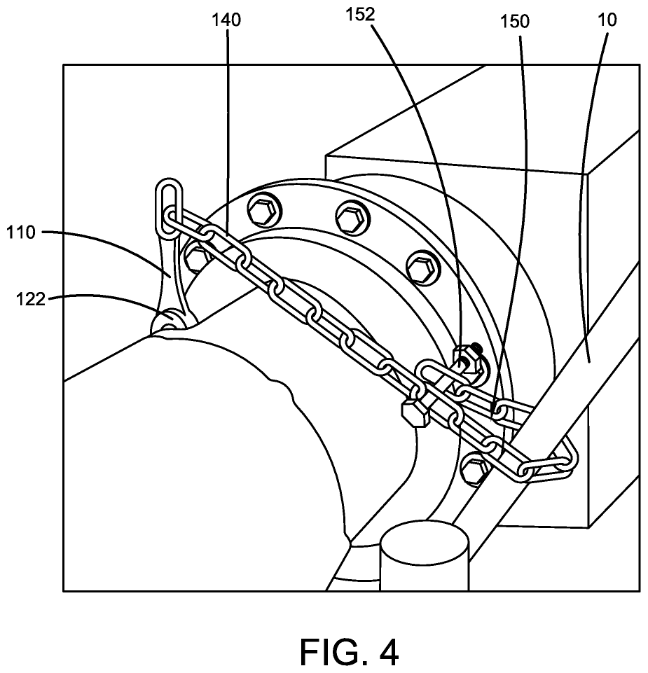

FIG. 2 illustrates a flow chart of a method 200 of using one potential embodiment of a tight space wrench device 100 of the present invention in accordance with the disclosed architecture. The device 100 is also comprised of a method of use 200. The second end 146 of the chain 140 may be comprised of at least one loop 150. In one embodiment, the loop 150 is adjustable in size via at least one fastener 152 such as, but not limited to, a nut and bolt assembly that allows the loop 150 to be formed at differing parts of the chain 140. In a differing embodiment, the size of the loop 150 is fixed. In a further embodiment, the chain 140 may have no loop, as seen in FIG. 3. The loop 150 functions as a handle that can be grabbed by the user. In this manner, the wrench member 110 can be attached to a nut, bolt, fastener, etc., in a hard-to-reach area [Step 202]. The chain 140 can then be positioned away from said area in a space where the user's hand is not susceptible to injury due to a small space [Step 204]. The loop 150 can then be grabbed by the user and pulled, such that the wrench member 110 rotates clockwise or counterclockwise to tighten or loosen whatever the wrench member 110 is engaging [Step 206]. In a differing embodiment, a pry bar 10 or another long tool can be inserted into the loop 150 such that the pry bar 10 can be used to pull the chain 140, such that the wrench member 110 rotates clockwise or counterclockwise to tighten or loosen whatever the wrench member 110 is engaging, as seen in FIG. 4 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tight space wrench device” and “device” are interchangeable and refer to the tight space wrench device 100 of the present invention.

Notwithstanding the foregoing, the tight space wrench device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the tight space wrench device 100 as shown in the FIGS. are for illustrative purposes only, and that many other sizes and shapes of the tight space wrench device 100 are well within the scope of the present disclosure. Although the dimensions of the tight space wrench device 100 are important design parameters for user convenience, the tight space wrench device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tight space wrench device comprising:
a wrench member comprised of a first end and a second end;
a wrench head positioned on the first end; and
a chain attached to the second end.

2. The tight space wrench device of claim 1, wherein the wrench head is a crescent wrench head.

3. The tight space wrench device of claim 1, wherein the wrench head is a box wrench head.

4. The tight space wrench device of claim 1, wherein the chain is fixedly attached to the second end via a weld.

5. A tight space wrench device comprising:
a wrench member comprised of a first end and a second end having an opening;
a wrench head positioned on the first end; and
a chain attached to the second end through the opening, wherein the chain is comprised of a loop.

6. The tight space wrench device of claim 5, wherein the chain attaches through the opening via a fastener.

7. The tight space wrench device of claim 6, wherein the chain is adjustable in length.

8. The tight space wrench device of claim 6, wherein the fastener is a ball and socket joint.

9. The tight space wrench device of claim 6, wherein the fastener is a clip.

10. The tight space wrench device of claim 6, wherein the fastener is a hinge.

11. A tight space wrench device comprising:
a wrench member comprised of a first end and a second end having an opening;
a wrench head; and
a chain attached to the second end through the opening, wherein the chain is comprised of a loop.

12. The tight space wrench device of claim 11, wherein the wrench head is an open-ended wrench, a line wrench, a torque wrench, an adjustable wrench, a ratchet wrench, a socket wrench, a monkey wrench, a pedal wrench, an armorers wrench, a pliers wrench, an Allen wrench, a universal wrench, an oil filter wrench, a crowfoot wrench, a basin wrench bob or a pipe wrench head.

13. The tight space wrench device of claim 11, wherein the wrench head is comprised of a first fastener and the wrench member is comprised of a second fastener.

14. The tight space wrench device of claim 13, wherein the first fastener and the second fastener are a pair of reciprocating fasteners.

15. The tight space wrench device of claim 11, wherein the chain is comprised of a flexible covering.

16. The tight space wrench device of claim 15, wherein the flexible covering is textured.

17. The tight space wrench device of claim 11, wherein the size of the loop is adjustable via a fastener.

18. The tight space wrench device of claim 17, wherein the fastener is a nut and bolt assembly.

19. The tight space wrench device of claim 11, wherein the chain is comprised of a dipped covering.

20. The tight space wrench device of claim 11, wherein the chain is comprised of a linked chain.
